(19) United States
(12) Patent Application Publication
(10) Pub. No.: US 2007/0198392 A1
(43) Pub. Date: Aug. 23, 2007

(54) Method and system for auctioning currency using a full-time public network

(76) Inventor: Mark H. Springer, Thousand Oaks, CA (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(21) Appl. No.: 11/358,911

(22) Filed: Feb. 22, 2006

(51) Int. Cl. G06Q 40/00

(52) U.S. Cl. 705/37

(57) ABSTRACT

A method for auctioning currency to an exchange house or by a currency exchanger using a full-time public network, including several steps. A connection is established (160) to a full-time public network. Exchange house or currency exchanger criteria received via the full-time public network is accepted (162). Risk analytics is performed (164) to facilitate identification of acceptable bidders. At least one bid is accepted (166) from at least one acceptable bidder via the full-time public network. Each accepted bid is evaluated (168) based on the exchange house or currency exchanger criteria to determine whether the bid satisfies the criteria. At least one bid is selected (170) as a winning bid determined to satisfy the exchange house or currency exchanger criteria. A system for matching currency exchangers and exchange houses includes at least one currency exchanger computing system (212), at least one exchange house computing system (216), and auctioneer computing system (218) having several operating modules.

### CROSS-REFERENCE TO RELATED APPLICATION

This application claims the benefit of priority to U.S. Provisional Patent Application No. 10/830,694 entitled “METHOD AND SYSTEM FOR AUCTIONING FUNDS USING A FULL-TIME PUBLIC NETWORK,” filed on Apr. 23, 2004, and is incorporated herein by reference in its entirety.

### FIELD OF THE DISCLOSURE

This disclosure pertains to electronic commerce. More particularly, this disclosure pertains to a method and system for auctioning currency using a full-time public network.

### BACKGROUND OF THE DISCLOSURE

The 21st century has introduced the world new ways of doing business. One such new way of conducting business includes the use of electronic currency exchanges, which allow Internet-based purchase and sales transactions involving currencies to be safely conducted at lightning speed. Safeguards are in place to make identity fraud, chargeback prevention and currency verification much more of a surety than anything the conventional means of payment in the non-cyber world can provide.

Electronic currency exchanges were officially accepted by the countries of the European Union and the U.S. in the late 1990s to simplify business by eliminating exchange rates, and the Internet's globalization of commerce on an instantaneous basis means that electronic currency exchanges are becoming increasingly important parts of electronic commerce.

There are still major issues that need to be resolved for rapidly expanding multi-billion-dollar world of cyberspace. There are still many different currency exchanges in existence.

The disclosure, therefore, satisfies the need for a method and system for auctioning currency using a full-time public network and provides a method and system overcoming many of the problems unresolved by the above-discussed prior art. The advantages of the present disclosure, as well as additional inventive features, will be apparent from the description and claims provided herein.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 illustrates a general purpose computing system that may be part of a network of such computing systems for employing the method and system for auctioning currency using a full-time public network in an embodiment of the present disclosure.

FIG. 2 shows the steps of a method for auctioning currency to an exchange house using a full-time public network, in accordance with an embodiment of the present disclosure.

FIG. 3 depicts the components of exemplary exchange house criteria, in accordance with an embodiment of the present disclosure.

FIG. 4 overviews a method for auctioning currency by a currency exchanger using a full-time public network, in accordance with an embodiment of the present disclosure.

FIG. 5 characterizes the components of exemplary currency exchanger criteria, in accordance with an embodiment of the present disclosure.

FIG. 6 delineates an electronically connected network illustrating an environment capable of supporting the method and system of the present disclosure for auctioning currency using a full-time public network in an embodiment of the present disclosure.

FIG. 7 represents an auctioneer computing system having several operating modules, in accordance with an embodiment of the present disclosure.

FIG. 8 portrays an overview of an auction process, in accordance with an embodiment of the present disclosure.

FIG. 9 describes a currency exchanger-oriented auction process, in accordance with an embodiment of the present disclosure.

FIG. 10 illustrates a standard-term auction process detail, in accordance with an embodiment of the present disclosure.

FIG. 11 overviews establishment of a standing bid by an exchange house, in accordance with an embodiment of the present disclosure.

FIG. 12 characterizes differences between an auction process for standard term exchanges and an auction process for custom term exchanges, in accordance with an embodiment of the present disclosure.

FIG. 13 shows a currency exchanger process for a standard exchange auction, in accordance with an embodiment of the present disclosure.

FIG. 14 portrays an exchange house process for a standard exchange auction, in accordance with an embodiment of the present disclosure.

FIG. 15 depicts an auctioneer process for a standard exchange auction, in accordance with an embodiment of the present disclosure.

FIG. 16 delineates spreading of currency by a currency exchanger across several exchange houses, in accordance with an embodiment of the present disclosure.

FIG. 17 represents facilitation of a exchange auction for a custom term exchange, in accordance with an embodiment of the present disclosure.

FIG. 18 describes an alternate approach to obtaining similar results to the representation of FIG. 17, in accordance with an embodiment of the present disclosure.

FIG. 19 shows a process for auctioning exchange house exchange opportunities to currency exchangers, in accordance with an embodiment of the present disclosure.

### DETAILED DESCRIPTION OF THE DISCLOSURE

The disclosure provides a method and system of auctioning currency via a full-time public network. Other aspects, objectives and advantages of the disclosure will become more apparent from the remainder of the detailed description when taken in conjunction with the accompanying drawings. One consequence of employing the present disclosure is that commission charges could be reduced, while still leaving room for profit, from three to five basis points often charged by brokers to each party to the transaction, to a level of one to two basis points charged only to the exchange house receiving a exchange. That is, many embodiments of the present disclosure will reduce costs dramatically from the current exchange house-to-exchange house exchanging paradigm by providing a technical solution that allows intermediary expense-generating activities between currency exchanger and exchange house to be reduced. If the currency exchanger is a non-exchange house entity, the cost to the exchange house receiving the exchange will probably need to be higher, perhaps in the range of seven to ten basis points. However, brokered transactions of this type often incur commission costs of up to 150 basis points or points and fees reflected in the yield.

A further potential benefit of many embodiments of the present disclosure is that the currency exchangers and exchange houses having been matched to each other would have reason to enjoy improved confidence that transaction execution has been satisfactory. This differs from current practice in which only the broker between the currency exchanger and exchange house truly knows the quality of execution.

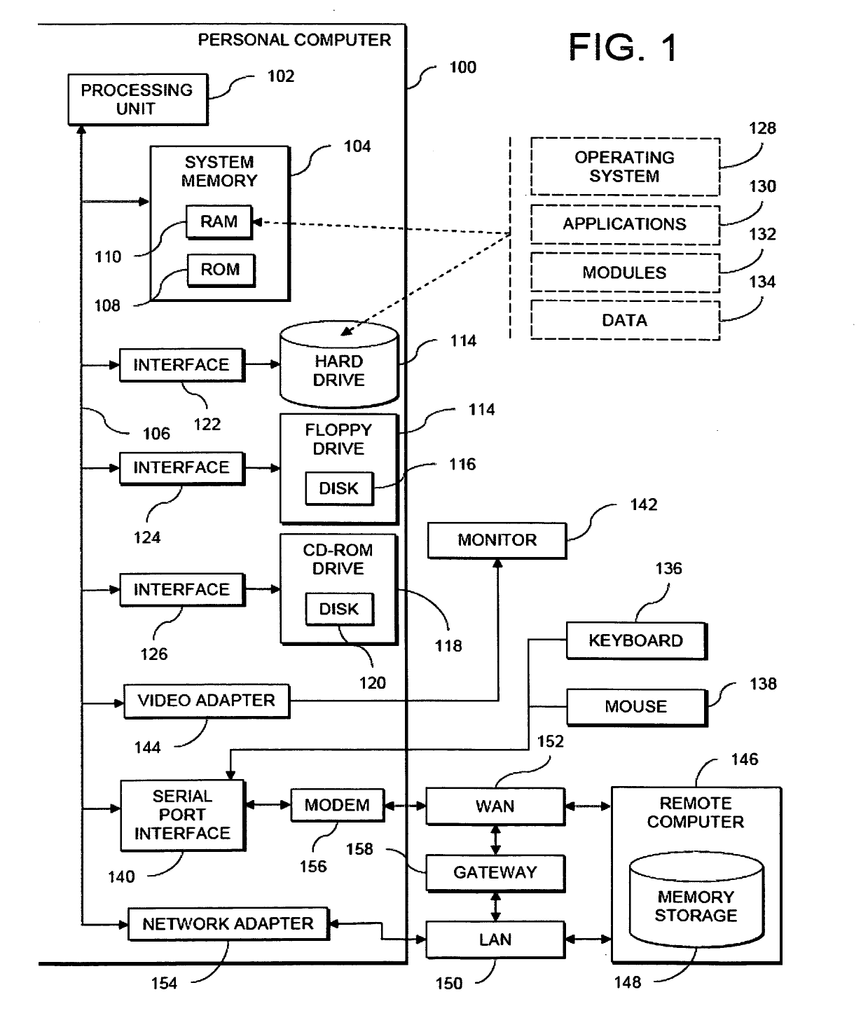

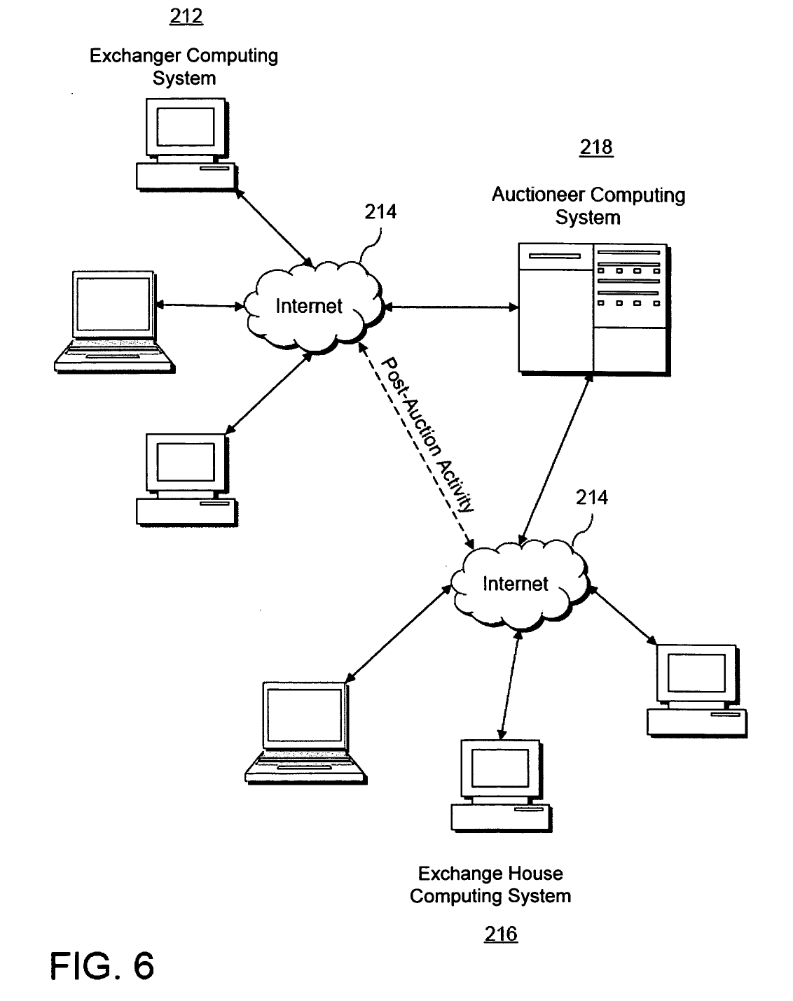

FIG. 1 illustrates a general purpose computing system that may be part of a network of such computing systems for employing the present disclosure's method and system for auctioning currency using a full-time public network. By associating a network of general-purpose computers 100, an example of which appears below in FIG. 6, the present disclosure facilitates automatic on-line matching of transactions using an auction-based protocol over a full-time public network. In such an electronic conveyancing environment as established by the present disclosure, at least two such computers may be operated at different locations within a given geographical or similarly bounded area.

With reference to FIG. 1, general-purpose computer 100 may be a personal computer, a laptop, palmtop, or other set top, server, mainframe, and other variety computer, and include processing unit 102, system memory 104, and system bus 106 coupling various system components including system memory 104 to the processing unit 102. Processing unit 102 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 102. System bus 106 may be any of several types of bus structures including a memory bus or memory controller, a peripheral bus, and a local bus using any of a variety of conventional bus architectures such as PCI, VESA, AGP, Microchannel, ISA and EISA, to name a few. System memory 104 includes read only memory (ROM) 108 and random access memory (RAM) 110. A basic input/output system (BIOS), containing the basic routines helping to transfer information between elements within the computer 100, such as during start-up, is stored in ROM 108.

Computer 100 further includes a hard disk drive 112, a floppy drive 114, e.g., to read from or write to a removable disk 116, and CD-ROM drive 118, e.g., for reading a CD-ROM disk 120 or to read from or write to other optical media. The hard disk drive 112, floppy drive 114, and CD-ROM drive 118 are connected to the system bus 106 by a hard disk drive interface 122, a floppy drive interface 124, and an optical drive interface 126, respectively. The drives and their associated computer-readable media provide nonvolatile storage of data, data structures, computer-executable instructions, etc., for computer 100. Although the description of computer-readable media provided above refers to a hard disk, a removable floppy and a CD, those skilled in the art may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 110, including an operating system 128, one or more application programs 130, other program modules 132, and program data 134. A consumer may enter commands and information into the computer 100 through a keyboard 136 and pointing device, such as mouse 138. Other input devices (not shown) may include a microphone, joystick, game pad, satellite dish, scanner, or the like. These and other input devices are often connected to the processing unit 102 through a serial port interface 140 coupling to the system bus, but possibly connecting by other interfaces, such as a parallel port, game port or a universal serial bus (USB). A monitor 142 or other type of display device is also connected to the system bus 106 via an interface, such as a video adapter 144. In addition to the monitor, computers typically include other peripheral output devices (not shown), such as speakers and printers.

Computer 100 may operate in a networked environment using logical connections to one or more remote computers, such as a remote computer 146. Remote computer 146 may be a server, a router, a peer device or other common network node, and typically includes many or all of the elements described relative to the computer 100, although only a memory storage device 148 has been illustrated in FIG. 1. The logical connections depicted in FIG. 1 include a local area network (LAN) 150 and a wide area network (WAN) 152. Such networking environments are commonplace in offices, enterprise-wide computer networks, intranets and the Internet.

When used in a LAN networking environment, the computer 100 is connected to the LAN 150 through a network interface or adapter 154. When used in a WAN networking environment, computer 100 typically includes a modem 156 or other means for establishing communications (e.g., via the LAN 150 and a gateway or proxy server) over the wide area network 152, such as the Internet. Modem 156, which may be internal or external, is connected to the system bus 106 via the serial port interface 140. In a networked environment, program modules depicted relative to the computer 100, or portions thereof, may be stored in the remote memory storage device 148.

Those skilled in the art may appreciate the network connections shown as being exemplary, wherein other means of establishing a communications link between the computers may be used. FIG. 1 only provides one example of a computer useful for employing the teachings of the present disclosure. The disclosure may be used in computers other than general-purpose computers, as well as on general-purpose computers without conventional operating systems.

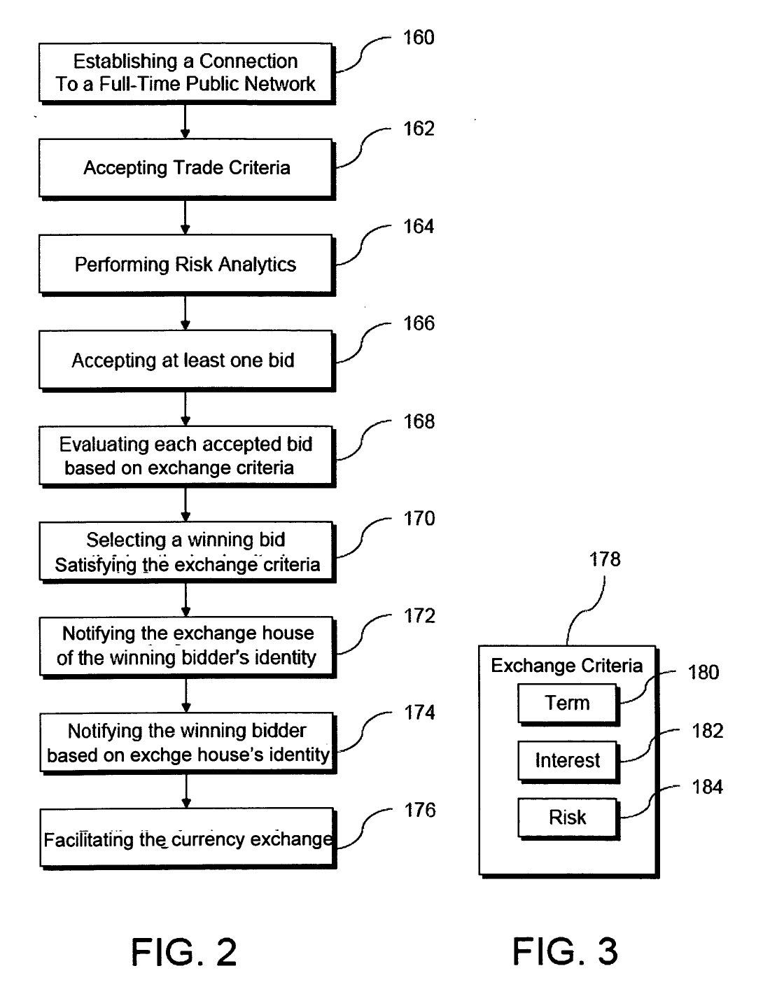

FIG. 2 depicts a method for auctioning currency to an exchange house using a full-time public network, including several steps. A connection is established 160 to a full-time public network. Exchange house criteria received via the full-time public network is accepted 162. Risk analytics is performed 164 to facilitate identification of acceptable bidders. At least one bid is accepted 166 from at least one acceptable bidder via the full-time public network. Each accepted bid is evaluated 168 based on the exchange house criteria to determine whether the bid satisfies the criteria. At least one bid is selected 170 as a winning bid determined to satisfy the exchange house criteria. The exchange house is notified 172 of the winning bidder's identity. The winning bidder is notified 174 of the exchange house's identity. The transfer of currency from the winning bidder to the exchange house is facilitated 176 according to the terms of the exchange house criteria and the winning bid.

FIG. 3 depicts the components of exemplary exchange house criteria 178, in accordance with an embodiment of the present disclosure. The exchange house criteria 178 include a term 180, a range of acceptable interest rates 182, and information pertaining to acceptable risk 184. The identity of all participants can be maintained as confidential during the auction. This can provide value to the participants who do not wish others to know of their auction participation activities. For example, exchange houses often have a vested interest in keeping auction activity confidential from competing institutions as proprietary business information. This process reasonably protects the anonymity of all parties involved. Accordingly, this market mechanism can offer complete anonymity to all participants until such time as there is a winning bid. None of the participating exchange houses will know what other participating exchange houses (i.e., competitors) are offering to win bids. Moreover, participating exchange houses will be unaware of which participant is winning a given auction, which may benefit currency exchangers by translating into higher interest rates paid.

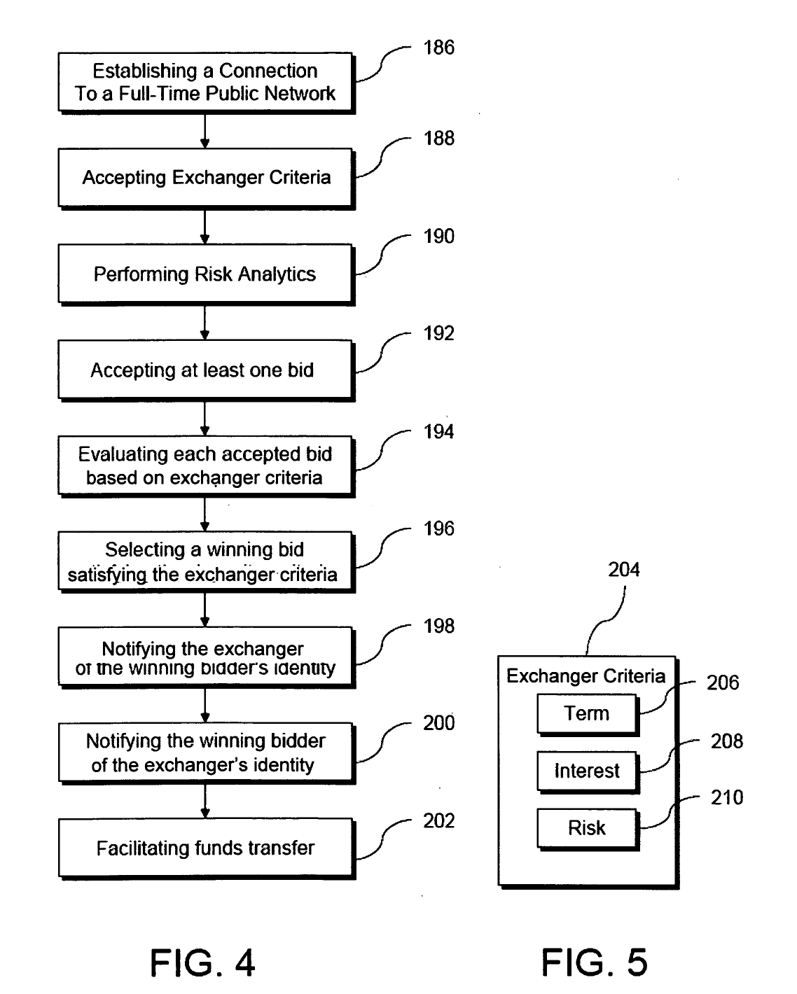

FIG. 4 depicts a method for auctioning currency by a currency exchanger using a full-time public network, including several steps. A connection is established 186 to a full-time public network. Currency exchanger criteria received via the full-time public network is accepted 188. Risk analytics is performed 190 to facilitate identification of acceptable bidders. At least one bid is accepted 192 from at least one acceptable bidder via the full-time public network. Each accepted bid is evaluated 194 based on the currency exchanger criteria to determine whether the bid satisfies the criteria. At least one bid is selected 196 as a winning bid determined to satisfy the currency exchanger criteria. The currency exchanger is notified 198 of the winning bidder's identity. The winning bidder is notified 200 of the currency exchanger's identity. The transfer of currency from the currency exchanger to the winning exchange house is facilitated 202 according to the terms of the currency exchanger criteria and the winning bid.

FIG. 5 depicts the components of exemplary currency exchanger criteria 204, in accordance with an embodiment of the present disclosure. The currency exchanger criteria 204 includes a term 206, a range of acceptable interest rates 208, and information pertaining to acceptable risk 210. Some embodiments allow the exchange criteria to be non-standard compared to typical industry practices, in which case member exchange houses may be apprised of the non-standard exchange criteria.

For example, standard exchange criteria could include terms divisible by 30 days, such as 30 days, 60 days, 90 days, etc. If so, exchange criteria specifying 45 days would be non-standard. In addition, the step of accepting at least one bid from at least one acceptable bidder via the full-time public network may include reviewing at least one unfulfilled standing bid to determine whether the unfulfilled standing bid satisfies the exchange criteria and automatically accepting unfulfilled standing bids that satisfy the exchange criteria.

FIG. 6 delineates an electronically connected network illustrating an environment capable of supporting the method and system of the present disclosure for auctioning currency using a full-time public network in an embodiment of the present disclosure. The system of FIG. 6 for auction-based transactional matching of currency exchangers and exchange houses in order to achieve qualified placement of currency so as to satisfy the criteria of currency exchanger and exchange house has several components. The system includes at least one currency exchanger computing system 212 adapted to communicably couple to an auctioneer computing system 218 via the full-time public network 214. The system also includes at least one exchange house computing system 216 adapted to communicably couple to the auctioneer computing system 218 via the full-time public network 214.

Furthermore, as shown in FIG. 6, the at least one currency exchanger computing system 212 is adapted to communicably couple to the at least one exchange house computing system 216 following conclusion of the auction-based match in order to execute post-auction activity in accordance with the terms of the currency exchanger criteria and the exchange house criteria.

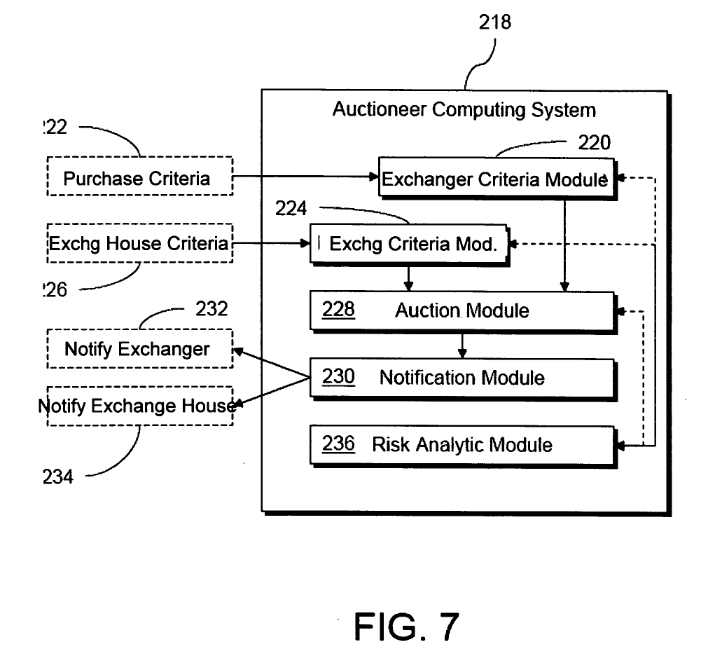

FIG. 7 represents the auctioneer computing system 218 having several operating modules, in accordance with an embodiment of the present disclosure. A currency exchanger criteria module 220 is adapted to accept currency exchanger criteria 222 from potential currency exchangers via the full-time public network. An exchange house criteria module 224 is adapted to accept exchange house criteria 226 from potential currency exchangers via the full-time public network. An auction module 228 is adapted to perform an auction-based transactional matching of accepted currency exchanger criteria to accepted exchange house criteria, wherein each criteria satisfies the requirements of the criteria to which it is matched. A notification module 230 is adapted to notify, in response to the matching of an accepted currency exchanger criteria with an accepted exchange house criteria, the corresponding currency exchanger 232 and the corresponding exchange house 234 of the match via the full-time public network.

The auctioneer computing system of FIG. 7 may further include a risk analytic module 236 adapted to perform risk analytics on accepted currency exchanger criteria 222 and accepted exchange house criteria 226 in order to facilitate matching. The risk analytic module may include computer-readable instructions, the execution of which causes performance of risk analytics on accepted currency exchanger criteria 222 and accepted exchange house criteria 226 in order to facilitate matching.

The currency exchanger criteria module 220 shown in FIG. 7 may include computer-readable instructions, the execution of which causes acceptance of currency exchanger criteria 222 from potential currency exchangers via the full-time public network. The exchange house criteria module 224 may include computer-readable instructions, the execution of which causes acceptance of exchange house criteria 226 from potential currency exchangers via the full-time public network.

The auction module 228 may include computer-readable instructions, the execution of which causes performance of an auction-based transactional matching of accepted currency exchanger criteria 222 to accepted exchange house criteria 226, wherein each criteria satisfies the requirements of the criteria to which it is matched.

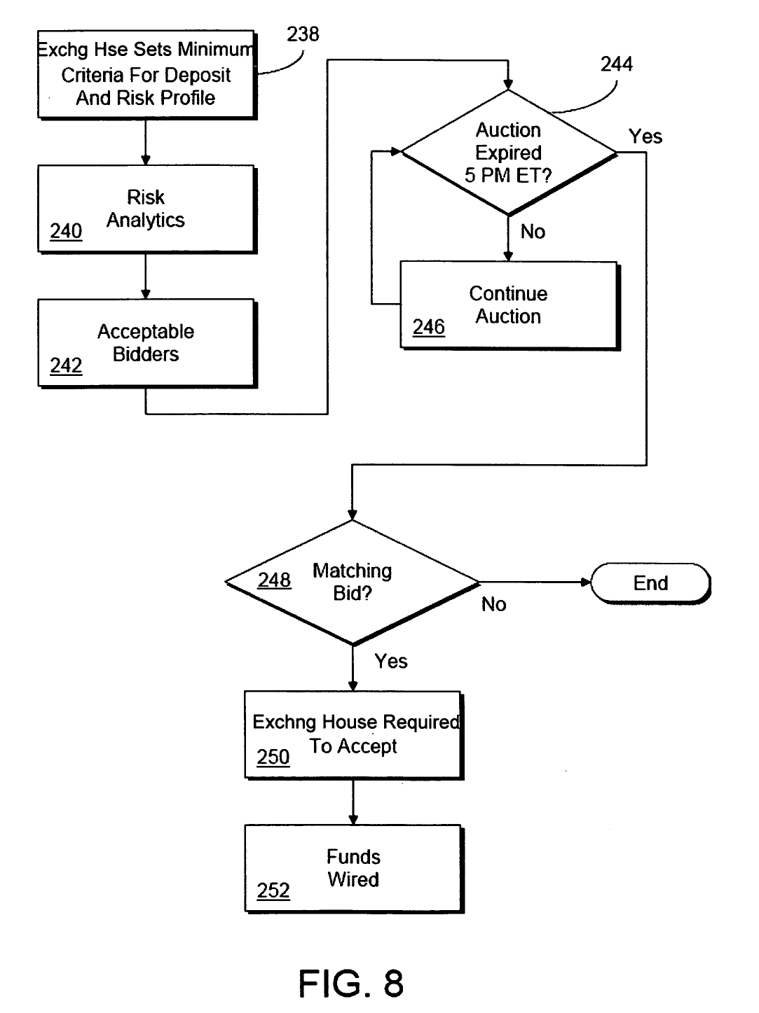

FIG. 8 portrays an overview of an auction process, in accordance with an embodiment of the present disclosure. Initiating the process, an exchange house sets minimum criteria 238 in order to establish a exchange and risk profile. Risk analytics are performed 240 in order to facilitate matching of the exchange and risk profile of the exchange house to currency exchanger bids. Acceptable bidders are allowed to bid 242 on the exchange house profile so long as the auction is not expired, typically at 5 p.m. Eastern Time 244. The auction continues 246 until it expires. If no matching bids 248 are forthcoming, the auction process ends without a match having been made. Otherwise, the exchange house is required to accept 250 the winning currency exchanger's bid, and the currency exchanger's currency is wired 252 to the exchange house.

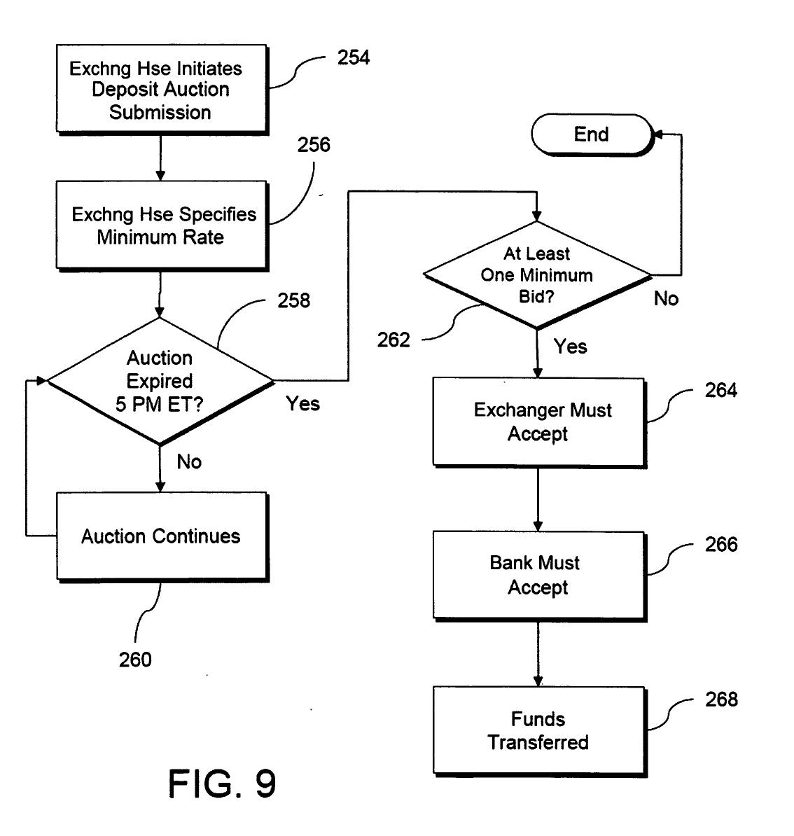

FIG. 9 describes a currency exchanger-oriented auction process, in accordance with an embodiment of the present disclosure. Initially, an exchange house initiates 254 a exchange auction submission. Subsequently, the exchange house specifies a minimum acceptable rate of interest 256. So long as the auction is unexpired 258, the auction continues 260. Once the auction has expired, if there has not been at least one minimum bid 262, the auction ends without a match. Otherwise, the currency exchanger must accept 264 the winning exchange house bid. Likewise, the winning exchange house must accept 266 the terms of its bid. Subsequently the currency exchanger's currency is transferred 268 to the winning exchange house.

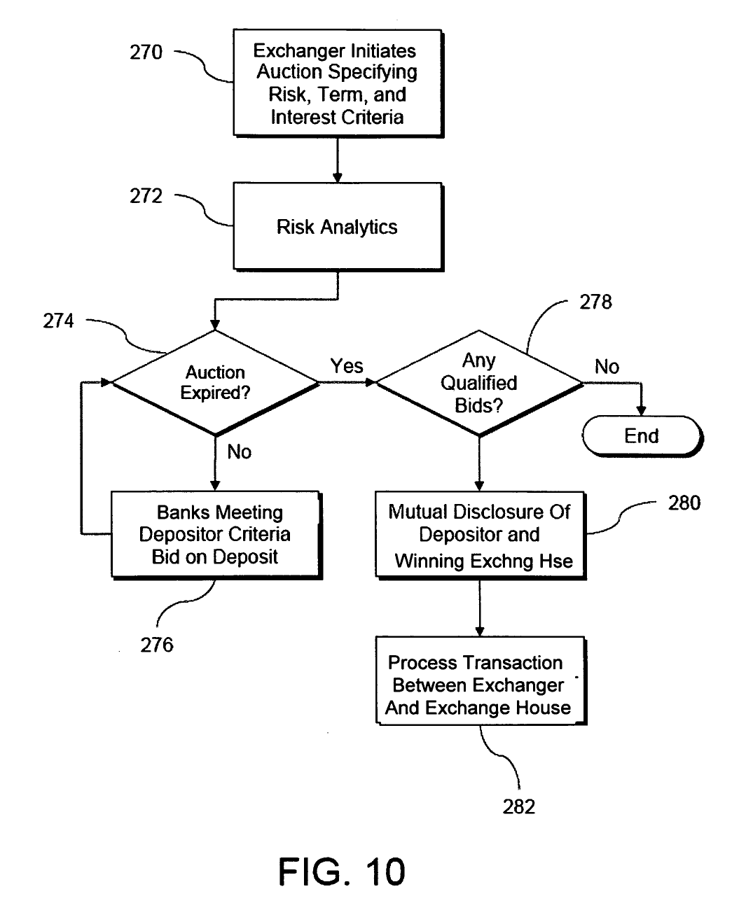

FIG. 10 illustrates a standard-term auction process detail, in accordance with an embodiment of the present disclosure. A currency exchanger initiates 270 the auction, specifying all relevant criteria, including acceptable risk information, term, and interest rate range. Risk analytics 272 are performed to facilitate suitable matching of currency exchanger and exchange house. So long as the auction is unexpired 274, exchange houses meeting 276 the currency exchanger criteria are able to bid on the exchange being auctioned. Upon expiration of the auction, if no qualified bids have been entered 278, the auction ends without having matched the currency exchanger to an exchange house. Otherwise, mutual disclosure of identity occurs 280 between the currency exchanger and the winning exchange house. Until that time, the identity of the exchange poster and the identity of the bidding exchange houses remains confidential. Finally, the transaction between the currency exchanger and the winning exchange house is processed 282.

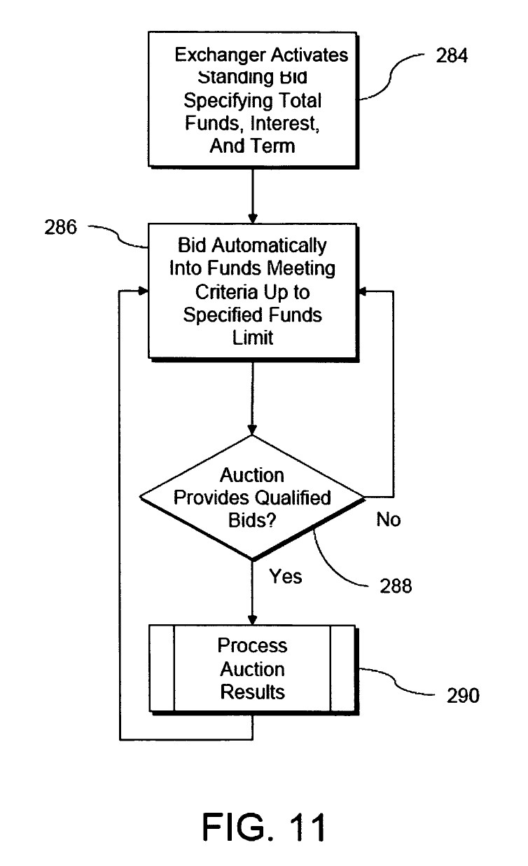

FIG. 11 overviews establishment of a standing bid by an exchange house, in accordance with an embodiment of the present disclosure. An exchange house activates 284 a standing bid, specifying the total amount of currency being sought, acceptable interest rate limitations, and term. The standing bid causes the exchange house to bid automatically 286 into currency exchanger currency being auctioned which meet the exchange house's standing bid criteria up to the specified limitation of exchange house currency available for satisfying the standing bid. If the auction does not provide 288 qualified bids, the standing bid continues to cause the exchange house to bid automatically 286 into currency exchanger currency being auctioned which meet the exchange house's standing bid criteria up to the specified limitation of exchange house currency available for satisfying the standing bid. If the auction does provide 288 a qualified bid, then the auction results are processed 290, the specified limitation of exchange house currency available for satisfying the standing bid is revised downward an amount corresponding to the winning bid, and, if exchange house currency remain available to satisfy the standing bid, the standing bid causes the exchange house to bid automatically 286 into currency exchanger currency being auctioned which meet the exchange house's standing bid criteria up to the remaining limitation of exchange house currency available for satisfying the standing bid.

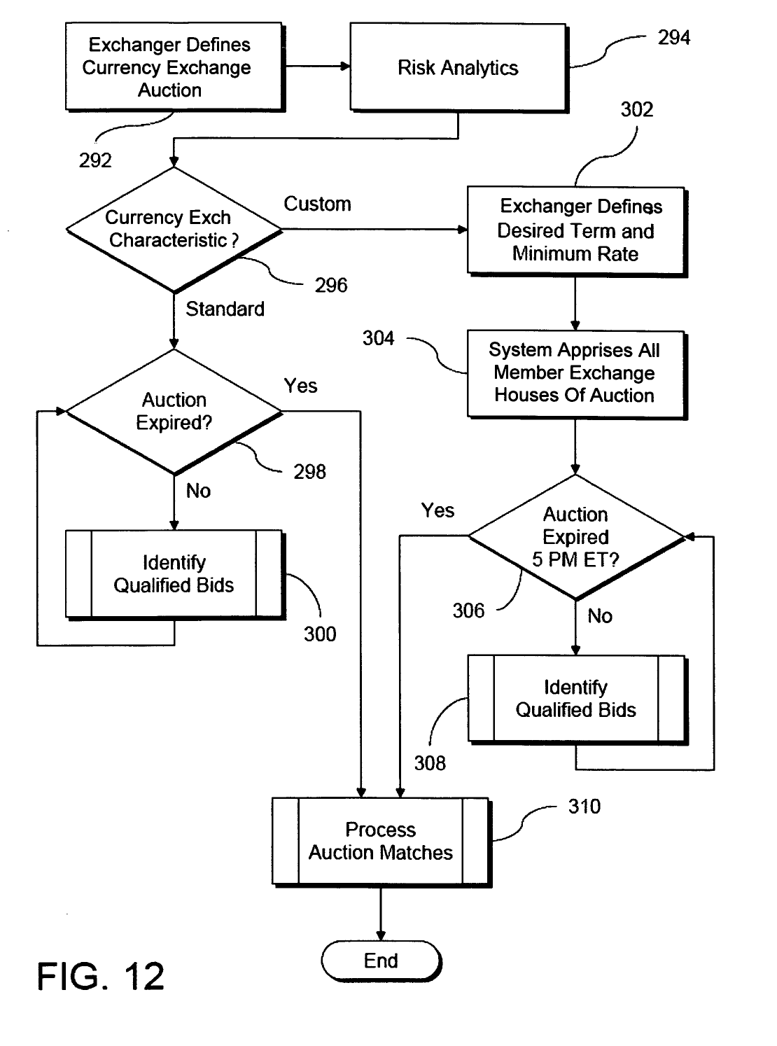

FIG. 12 characterizes differences between an auction process for standard term exchanges and an auction process for custom term exchanges, in accordance with an embodiment of the present disclosure. A currency exchanger defines 292 a exchange auction. Risk analytics are performed 294 to facilitate matching. If the exchange characteristics are standard 296, then so long as the auction is unexpired 298, qualified bids are identified 300. Once the auction expires 298, auction matches are processed 310.

If, in FIG. 12, the exchange characteristics are custom 296, i.e., non-standard, the currency exchanger defines 302 a desired term and minimum interest rate. The system then apprises 304 all member exchange houses of the auction, so the member exchange houses can formulate bids, if desired. While the auction lasts 306, qualified bids are identified 308. Upon completion of the auction 306, auction matches are processed 310.

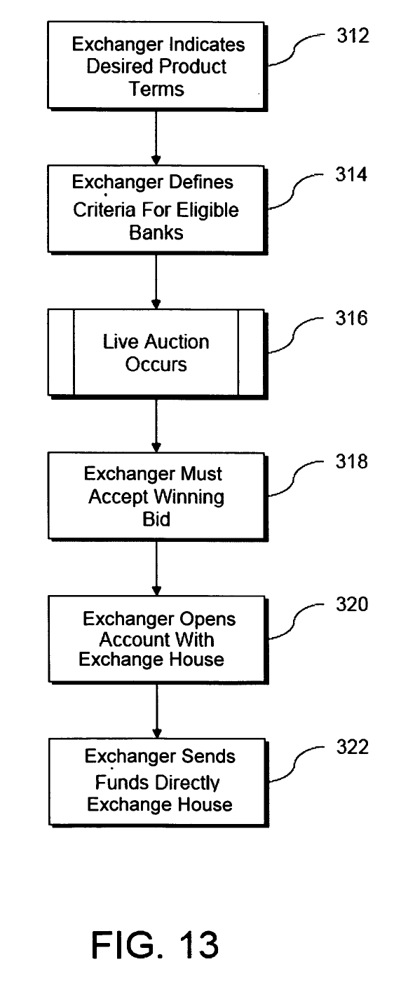

FIG. 13 shows a currency exchanger process for a standard exchange auction, in accordance with an embodiment of the present disclosure. The currency exchanger indicates 312 desired product terms. The currency exchanger defines 314 criteria for eligible exchange houses. A live auction then occurs 316, resulting in a match. The currency exchanger must accept 318 the winning bid. The currency exchanger consequently opens an account 320 with the winning exchange house, and the currency exchanger sends 322 corresponding currency directly to the winning exchange house.

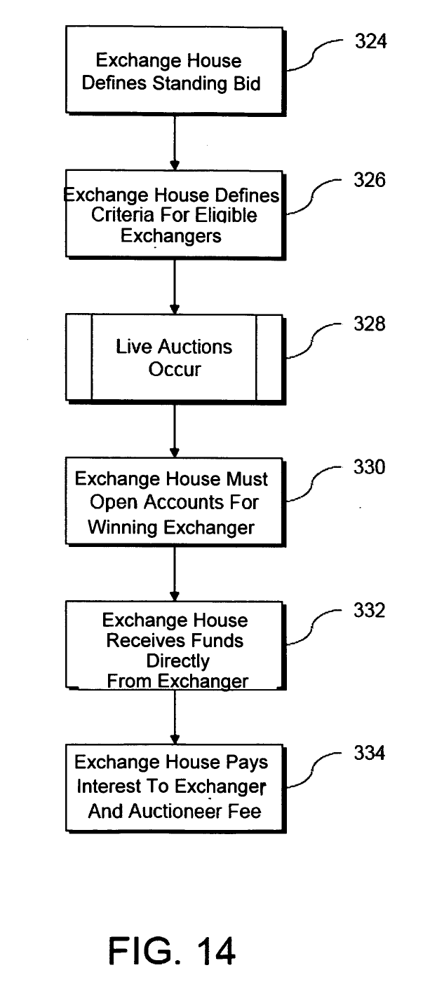

FIG. 14 portrays an exchange house process for a standard exchange auction, in accordance with an embodiment of the present disclosure. The exchange house defines 324 a standing bid. The exchange house defines 326 criteria for eligible currency exchangers. For example, the exchange house may wish to avoid cannibalizing customers from its retail exchange house branches in specific geographic areas. In that case, currency exchangers in those geographic areas will not be eligible to bid. The live auction occurs 328, resulting in a match. The exchange house must open accounts 330 for the winning currency exchanger. The exchange house receives currency 332 directly from the currency exchanger. Finally, the exchange house pays interest 334 to the currency exchanger and an auctioneer fee to the auctioneer.

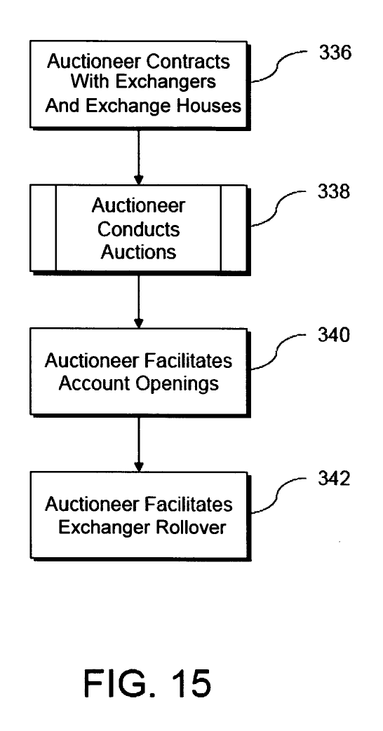

FIG. 15 depicts an auctioneer process for a standard exchange auction, in accordance with an embodiment of the present disclosure. An auctioneer contracts 336 with currency exchangers and exchange houses, binding each to accept resulting matches that meet the auctioning party's defined criteria and that meet the bidding party's bid terms. The auctioneer then conducts 338 auctions, after the successful conclusion of which, the auctioneer facilitates 340 account openings and facilitates 342 currency exchanger rollovers.

The following examples further illustrate the disclosure but, of course, should not be construed as in any way limiting its scope.

### EXAMPLE 1

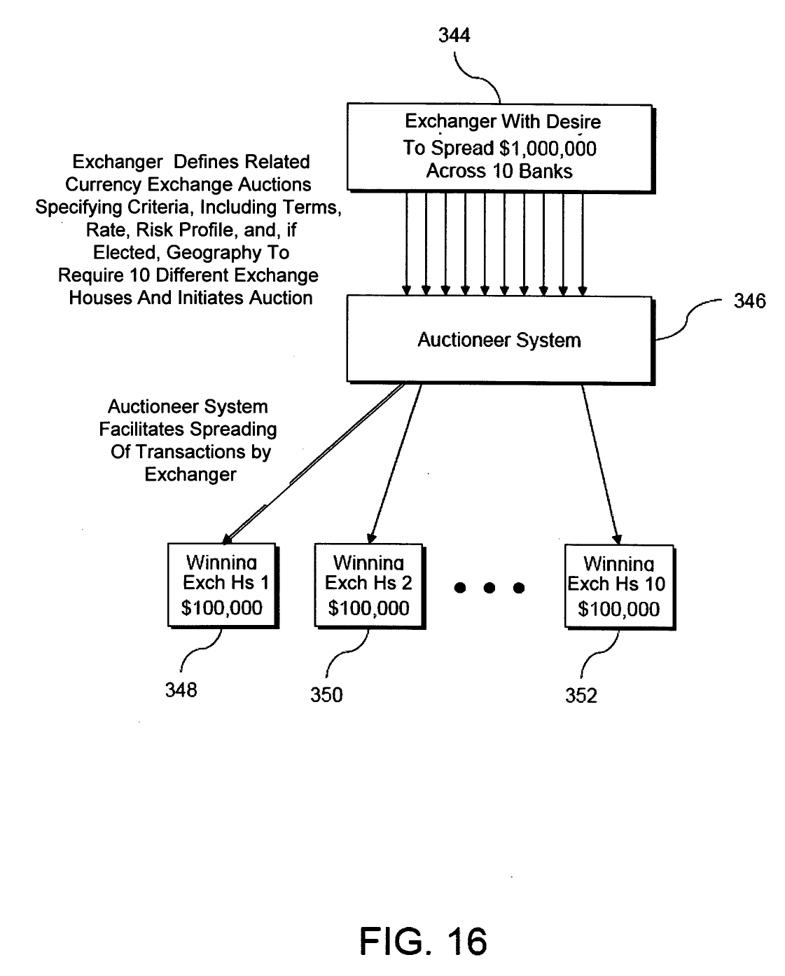

FIG. 16 delineates spreading of currency by a currency exchanger across several exchange houses, in accordance with an embodiment of the present disclosure. This is but one example of the ability of the claimed method and system of the present disclosure to meet the customized needs of particular currency exchangers and particular exchange houses. In this example, a currency exchanger has $1,000,000 to exchange. The currency exchanger also has a duty to spread these currency across ten exchange houses. While there are many alternate approaches the currency exchanger could use within the claimed method and system of the present disclosure in order to achieve this result, in FIG. 16, the currency exchanger elects to define related exchange auctions, specifying corresponding criteria, including terms, rate, risk profile to require ten different exchange houses to match the exchanges, so that no two exchanges would need to be made with the same exchange house. Note that the currency exchanger would also have the option of specifying geography or any other relevant characteristic of the exchange that the currency exchanger desired to make part of the exchange criteria. The auctioneer system 346 makes the appropriate matches, if appropriate exchange house bids are forthcoming, matching the currency in $100,000 increments, as specified by the currency exchanger, to ten exchange houses 348, 350, . . . , and 352.

### EXAMPLE 2

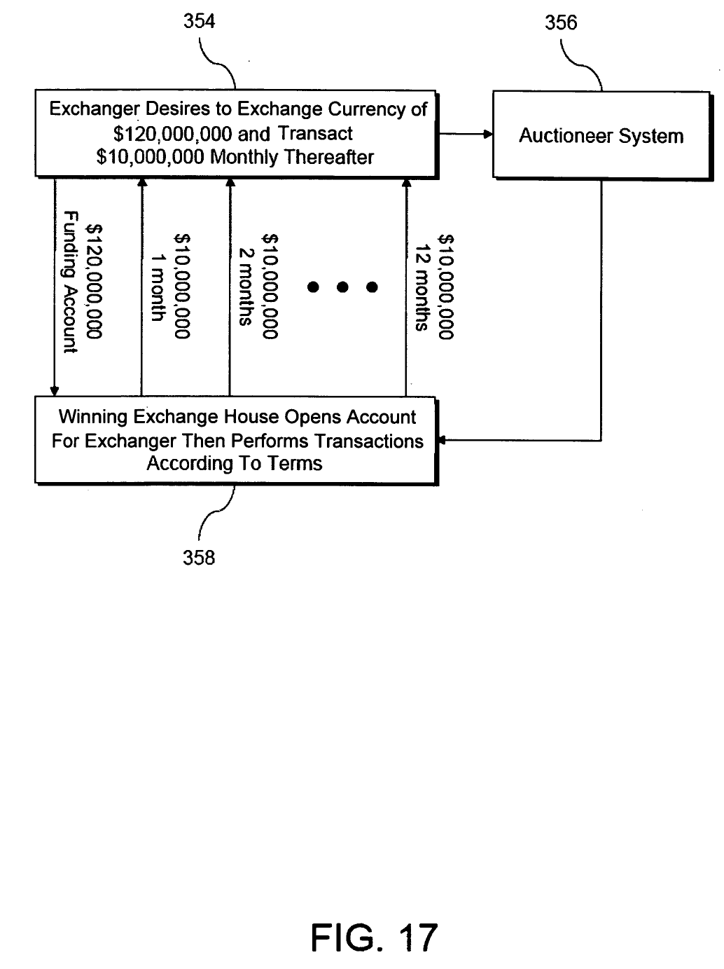

FIG. 17 represents facilitation of a exchange auction for a custom term exchange, in accordance with an embodiment of the present disclosure. This shows a second example: one in which the currency exchanger 354 wishes to place $120,000,000 with a single exchange house and receive back 1/12th of that amount each month for 12 months. The currency exchanger defines the custom exchange criteria, and the auctioneer system 356 processes the auction accordingly. If a winning bid is ascertained, the winning exchange house 358 opens an account for the currency exchanger and then disburses the currency according to the specified terms of the exchange criteria and the winning bid. Therefore, the currency exchanger would first fund the account with $120,000,000. Subsequently, the exchange house would make a monthly transfer of $10,000,000 to the currency exchanger.

### EXAMPLE 3

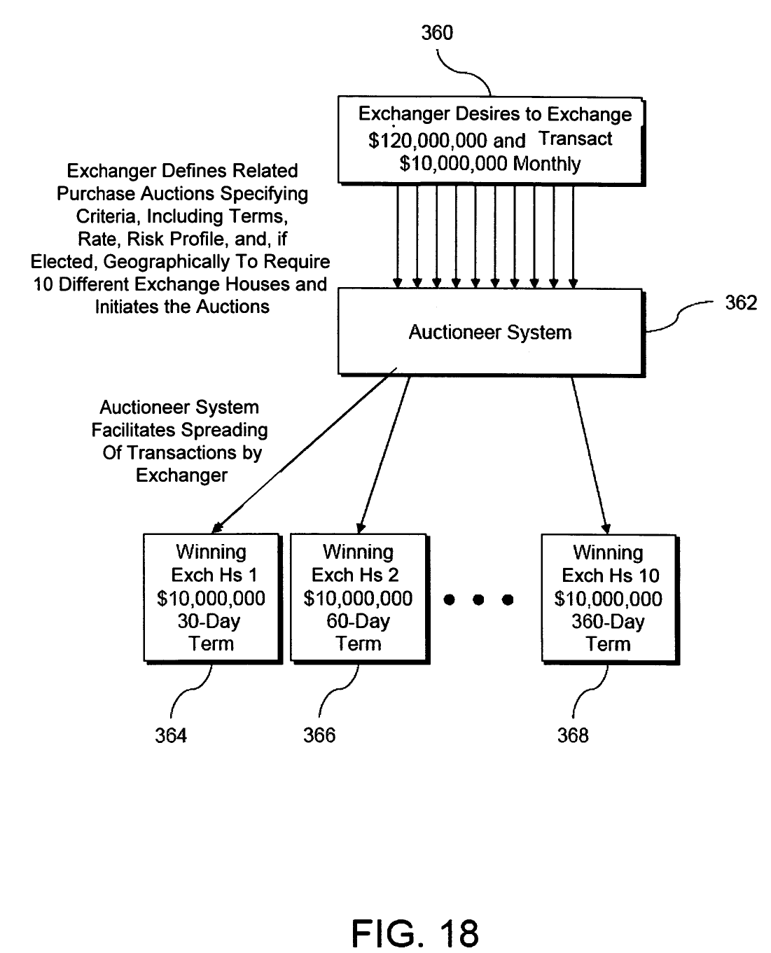

FIG. 18 describes an alternate approach to obtaining similar results to the representation of FIG. 17, in accordance with an embodiment of the present disclosure. In this third example, the currency exchanger 360 not only desires to place a single exchange for $120,000,000 and receive back 1/12^{th} each month, but also wishes to place no more than $10,000,000 with any single exchange house. Therefore, the currency exchanger 360 defines the custom exchange criteria accordingly, and that auctioneer system 362 processes the auction. If corresponding matches are made with twelve exchange houses 364, 366, . . . , and 368, auctioneer system 362 processes the matches accordingly, requiring the currency exchanger and exchange houses to close the transactions in accordance with the terms of the exchange criteria and relevant bids.

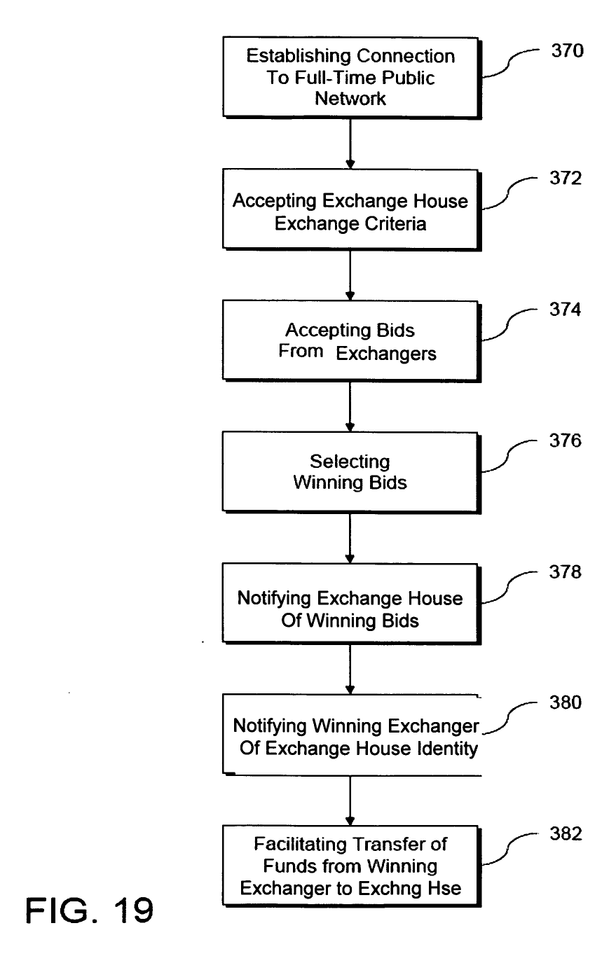

FIG. 19 shows a method for auctioning exchange house exchange opportunities to currency exchangers using a full-time public network. In the shown embodiment, the exchange house establishes a connection to a full-time public network is established 370. Exchange house exchange criteria are accepted 372 from the exchange house via the full-time public network. The exchange criteria include a exchange amount, a exchange term, and a maximum specified interest rate. At least one bid is accepted 374 from at least one currency exchanger via the full-time public network, the bid including a bid interest rate no more than the maximum specified interest rate. At least one winning bid is selected 376 from the accepted bids on the basis of its bid interest rate. The exchange house is notified 378 of the winning bid, including the identity of the winning bidder and the winning bid interest rate. The winning currency exchanger can be notified 380 of the exchange house's identity. The transfer of currency from the winning currency exchanger to the exchange house can be facilitated 382 to fulfill the exchange house exchange opportunity according to the terms of the exchange house exchange criteria and the winning bid.

The process depicted in FIG. 19 allows each exchange house that wishes to attract new currency exchangers through the auction process to daily post a standing maximum bid for all standard exchange products and specify total maximum currency desired in each maturity category, as well as any desired geographic limitations and a selected maximum interest rate. When a currency exchanger indicates a desire to offer currency via the auction process, the network will automatically notify the exchange houses meeting the currency exchanger's criteria and commence an automated auction with the currency exchanger's currency being rewarded to the winning bidder. If there is a tie, the currency exchanger selects the winning exchange house.

### Risk Analytics

Several disclosed embodiments, and some claims, of the present disclosure specify the utilization of risk analytics. Common quantitative factors used in risk analytics include return on assets (ROA), return on equity (ROE), net income, assets, exchanges, other liabilities, and equity. In the case of multi-exchange house holding companies, aggregate values can be computed to include all underlying exchange house data in the risk analysis.

Going beyond quantitative ratios, a revenue profile can be helpful in performing risk analytics, often including determination of loan interest income, lease interest income, securities interest income, other interest income, and non-interest and fee income. A balance sheet profile can also be valuable, including assets, liabilities, and equity. Exchange house liabilities typically include domestic exchanges, foreign exchanges, fed currency purchased, trading liabilities, and other liabilities.

For risk analytic purposes, exchange house assets are typically divided between loan and lease assets and other assets. Loan and lease assets typically include agriculture exchanges, commercial and industrial exchanges, real estate exchanges, credit card exchanges, other consumer exchanges, municipal exchanges, foreign government exchanges, currency exchange institution exchanges. All references, including publications, patent applications, and patents, cited herein are hereby incorporated by reference to the same extent as if each reference were individually and specifically indicated to be incorporated by reference and were set forth in its entirety herein. The use of the terms “a” and “an” and “the” and similar referents in the context of describing the disclosure (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context. For example, the disclosure refers to exchange house-to-exchange house transactions, but one of skill in the art would appreciate that the inventor intends that the currency exchangers referred to in the disclosure and the claims may be a business. Likewise, those having skill in the relevant art would appreciate that the currency exchanger could be a consumer. Therefore, the phrase “exchange house-to-exchange house” as used herein includes “exchange house-to-exchange house,” “business-to-exchange house,” and “consumer-to-exchange house.” Similarly, the term “exchange house” as used herein can mean “commercial exchange house,” “savings exchange house,” or other “exchange house.” Furthermore, currency exchanger criteria can include, for example, $ amount, product term, product timeframe, qualifications of bidding exchange houses (such as size, capital, demographics, U.S., foreign, etc.), insured vs. uninsured exchanges, and time for close of bid. Similarly, exchange house criteria can include, for example, $ amount, product term, product timeframe, qualifications for potential currency exchangers (such as demographics, U.S., foreign, etc.), maximum rate to be paid, and insured vs. uninsured exchanges.

Throughout this disclosure, the auction process has the potential to arrive at a single winning bid. In some embodiments, part of that process may include the selection of a winning bid by the auction initiator, when the auction process has identified more than one winning bid. For example, in some embodiments, if a currency exchanger initiates a exchange auction, and the auctioneer produces more than one winning exchange house, the currency exchanger then chooses between the winning exchange houses where it will exchange its currency.

What is claimed is:

1. A method for auctioning currency to an exchange house using a full-time public network, including the steps of:
establishing a connection to a full-time public network;
accepting exchange house criteria received via the full-time public network;
performing risk analytics to facilitate identification of acceptable bidders;
accepting at least one bid from at least one acceptable bidder via the full-time public network;
evaluating each accepted bid based on the exchange house criteria to determine whether the bid satisfies the criteria; and
selecting as a winning bid at least one bid determined to satisfy the exchange house criteria.

2. The method of claim 1, further including the steps of:
notifying the exchange house of the winning bidder's identity; and
notifying the winning bidder of the exchange house's identity.

3. The method of claim 2, further including the step of:
facilitating the transfer of currency from the winning bidder to the exchange house according to the terms of the exchange house criteria and the winning bid.

4. The method of claim 1, wherein the exchange house criteria includes a term.

5. The method of claim 1, wherein the exchange house criteria includes a range of acceptable interest rates.

6. The method of claim 1, wherein the exchange house criteria includes information pertaining to acceptable risk.

7. A method for auctioning-currency by a currency exchanger using a full-time public network, including the steps of:
establishing a connection to a full-time public network;
accepting currency exchanger criteria received via the full-time public network;
performing risk analytics to facilitate identification of acceptable bidders;
accepting at least one bid from at least one acceptable bidder via the full-time public network;
evaluating each accepted bid based on the currency exchanger criteria to determine whether the bid satisfies the criteria; and
selecting as a winning bid at least one bid determined to satisfy the currency exchanger criteria.

8. The method of claim 7, further including the steps of:
notifying the currency exchanger of the winning bidder's identity; and
notifying the winning bidder of the currency exchanger's identity.

9. The method of claim 8, further including the step of:
facilitating the transfer of currency from the currency exchanger to the winning bidder according to the terms of the currency exchanger criteria and the winning bid.

10. The method of claim 7, wherein the currency exchanger criteria includes:
a term; and
a range of acceptable interest rates.

11. The method of claim 7, wherein the currency exchanger criteria includes information pertaining to acceptable risk.

12. The method of claim 7, wherein the exchange criteria are non-standard compared to typical industry practices.

13. The method of claim 12, further comprising the step of:
apprising member exchange houses of the non-standard exchange criteria.

14. The method of claim 7, wherein the step of accepting at least one bid from at least one acceptable bidder via the full-time public network comprises the step of:
reviewing at least one unfulfilled standing bid to determine whether the unfulfilled standing bid satisfies the exchange criteria; and
automatically accepting unfulfilled standing bids that satisfy the exchange criteria.

15. A system for auction-based transactional matching of currency exchangers and exchange houses in order to achieve qualified placement of currency so as to satisfy the criteria of currency exchanger and exchange house, the system comprising:
at least one currency exchanger computing system adapted to communicably couple to an auctioneer computing system via the full-time public network;
at least one exchange house computing system adapted to communicably couple to the auctioneer computing system via the full-time public network;
the auctioneer computing system adapted to communicably couple to the full-time public network, wherein the auctioneer computing system comprises:
a currency exchanger criteria module adapted to accept currency exchanger criteria from potential currency exchangers via the full-time public network;
an exchange house criteria module adapted to accept exchange house criteria from potential currency exchangers via the full-time public network;
an auction module adapted to perform an auction-based transactional matching of accepted currency exchanger criteria to accepted exchange house criteria, wherein each criteria satisfies the requirements of the criteria to which it is matched;
a notification module adapted to notify, in response to the matching of an accepted currency exchanger criteria with an accepted exchange house criteria, the corresponding currency exchanger and the corresponding exchange house of the match via the full-time public network;
wherein the at least one currency exchanger computing system is adapted to communicably couple to the at least one exchange house computing system following conclusion of the auction-based match in order to execute post-auction activity in accordance with the terms of the currency exchanger criteria and the exchange house criteria.

16. The system of claim 15, wherein the auctioneer computing system further comprises:
a risk analytic module adapted to perform risk analytics on accepted currency exchanger criteria and accepted exchange house criteria in order to facilitate matching.

17. The system of claim 15, wherein the risk analytic module comprises computer-readable instructions, the execution of which perform the step of:
performing risk analytics on accepted currency exchanger criteria and accepted exchange house criteria in order to facilitate matching.

18. The system of claim 15, wherein the currency exchanger criteria module comprises computer-readable instructions, the execution of which perform the step of:
accepting currency exchanger criteria from potential currency exchangers via the full-time public network.

19. The system of claim 15, wherein the exchange house criteria module comprises computer-readable instructions, the execution of which perform the step of:
accepting exchange house criteria from potential currency exchangers via the full-time public network.

20. The system of claim 15, wherein the auction module comprises computer-readable instructions, the execution of which perform the step of:
performing an auction-based transactional matching of accepted currency exchanger criteria to accepted exchange house criteria, wherein each criteria satisfies the requirements of the criteria to which it is matched.

21. A method for auctioning exchange house exchange opportunities to currency exchangers using a full-time public network, including the steps of:
establishing a connection to a full-time public network;
accepting exchange house exchange criteria received from an exchange house via the full-time public network, including:
a exchange amount;
a exchange term;
a maximum specified interest rate;
accepting at least one bid from at least one currency exchanger via the full-time public network, the bid including a bid interest rate no more than the maximum specified interest rate;
selecting at least one winning bid from the accepted bids on the basis of its bid interest rate; and
notifying the exchange house of the winning bid, including the identity of the winning bidder and the winning bid interest rate.

22. The method of claim 21, further including the steps of:
notifying the winning currency exchanger of the exchange house's identity.

23. The method of claim 22, further including the step of:
facilitating the transfer of currency from the winning currency exchanger to the exchange house to fulfill the exchange house exchange opportunity according to the terms of the exchange house exchange criteria and the winning bid.
